(19) United States
(12) Patent Application Publication
(10) Pub. No.: US 2008/0080332 A1
(43) Pub. Date: Apr. 3, 2008

(54) RECORDING MEDIUM TYPE IDENTIFICATION METHOD AND DEVICE

(75) Inventors: Yao-lung Chuang, San-Chung City (TW); Po-wei Chang, Taipei City (TW)

Correspondence Address: MADSON & AUSTIN, 15 WEST SOUTH TEMPLE, SUITE 900, SALT LAKE CITY, UT, 84101, US

(73) Assignee: Media Tek Inc., Hsin-Chu City (TW)

(21) Appl. No.: 11/536,875

(22) Filed: Sep. 29, 2006

(51) Int. Cl. G11B 7/00

(52) U.S. Cl. 369/44.13

(57) ABSTRACT

A recording medium type identification method and device is disclosed. The method and device of the present invention may easily identify the type of a DVD disk. The present invention is to remove pre-pit components, if any, from a wobble signal obtained from an optical disk to be identified, comparing a first peak-to-peak level of the wobble signal before the pre-pit removal process to a second peak-to-peak level of the wobble signal subjecting to the pre-pit removal process, and determining the optical disk type according to the comparison result. Alternatively, the present invention is to band-pass filter the wobble signal of the optical disk to be identified with a frequency range defined based on a center frequency of the wobble of a predetermined type of optical disk, driving a spindle motor with the processed wobble signal, and determining the type of the optical disk according to the rotation condition of the spindle motor.

### TECHNICAL FIELD OF THE INVENTION

The present application relates to a recording medium such as a DVD optical disk, more specifically, to a method and device for optical disk type identification.

### BACKGROUND OF THE INVENTION

Many concerns and efforts are voiced about the development of a Digital Versatile Disk (DVD), of which the capacity of recording information has been significantly increased. Currently, there are several types of DVD disks. Among the various types of DVD disks, DVD− and DVD+ disks are widely and commonly used.

In use, there is no significant difference between DVD− disks and DVD+ disks. However, DVD− and DVD+ disks are very different from each other in format. The carrier frequency of the wobble of a DVD− type disk is 140.6 kHz, while the carrier frequency of the wobble of a DVD+ type disk is 817.4 kHz. In addition, for the DVD− type disk, the addressing information is recorded by pre-pits at lands between grooves of the disk; for the DVD+ type disk, the addressing information is recorded by the modulation of the grooves. Accordingly, a wobble signal obtained from the DVD− type disk, such as a DVD-R or DVD-RW disk, includes pre-pit pulses, as shown in FIG. 1A. In comparison, a wobble signal obtained from the DVD+ type disk, such as a DVD+R or DVD+RW disk, has no pre-pit pulses, as shown in FIG. 1B.

### SUMMERY OF THE INVENTION

An objective of the present invention is to provide a recording medium type identification method which may easily identify the type of a DVD disk. In a specific case, the method determines if the DVD disk is DVD− type or DVD+ type.

Another objective of the present invention is to provide a recording medium type identification device which may easily identify the type of a DVD disk. In a specific case, the device determines if the DVD disk is DVD− type or DVD+ type.

In accordance with an aspect of the present invention, the recording medium type identification is to remove pre-pit components, if any, from a wobble signal obtained from an optical disk, comparing the wobble signal before the pre-pit removal process to the wobble signal subjecting to the pre-pit removal process, and determining the optical disk type according to the comparison result. In an embodiment of the present invention, the peak-to-peak levels of the wobble signal before and after the pre-pit removal process are compared, and the optical disk type is determined according to the comparison result. The pre-pit removal process is implemented by using difference between the slew rates, levels, or frequencies of the wobble and pre-pit components of the wobble signal.

In accordance with another aspect of the present invention, the recording medium type identification is to set a spindle control parameter according to a predetermined type, using the parameter to process a wobble signal of an optical disk to be identified, driving a spindle motor with the processed wobble signal, and determining the type of the optical disk according to the rotation condition of the spindle motor. In an embodiment of the present invention, the wobble signal is processed by a band-pass filter with a range defined based on a center frequency of the wobble of the predetermined type of optical disk. The processed wobble signal is then used to drive the spindle motor. If the spindle motor rotates in a desired speed, the optical disk to be identified is determined as the predetermined type.

### BRIEF DESCRIPTION OF THE DRAWINGS

The present invention will be further described in details in conjunction with the accompanying drawings, wherein:

FIG. 1A shows a waveform of a wobble signal obtained from a DVD− type disk;

FIG. 1B shows a waveform of a wobble signal obtained from a DVD+ type disk;

FIG. 2A schematically and generally illustrates an identification method in accordance with the first embodiment of the present invention applied to a DVD− type disk;

FIG. 2B schematically and generally illustrates an identification method in accordance with an embodiment of the present invention applied to a DVD+ type disk;

FIG. 3 shows a flow chart of the method in accordance with the first embodiment of the present invention;

FIG. 4A schematically shows an example of a device implementing the method of the first embodiment in accordance with the present invention;

FIG. 4B schematically shows another example of a device implementing the method of the first embodiment in accordance with the present invention;

FIG. 4C schematically shows a further example of a device implementing the method of the first embodiment in accordance with the present invention;

FIG. 5A schematically and generally illustrates a first example of an identification method in accordance with a second embodiment of the present invention applied to a DVD− type disk;

FIG. 5B schematically and generally illustrates the first example of an identification method in accordance with the second embodiment of the present invention applied to a DVD+ type disk;

FIG. 6A schematically and generally illustrates a second example of an identification method in accordance with the second embodiment of the present invention applied to a DVD− type disk;

FIG. 6B schematically and generally illustrates the second example of an identification method in accordance with the second embodiment of the present invention applied to a DVD+ type disk;

FIG. 7 shows a flow chart of the method in accordance with the second embodiment of the present invention; and

FIG. 8 schematically shows an example of a device implementing the method of the second embodiment in accordance with the present invention.

### DETAILED DESCRIPTION OF THE INVENTION

The present invention will be described in details as follows.

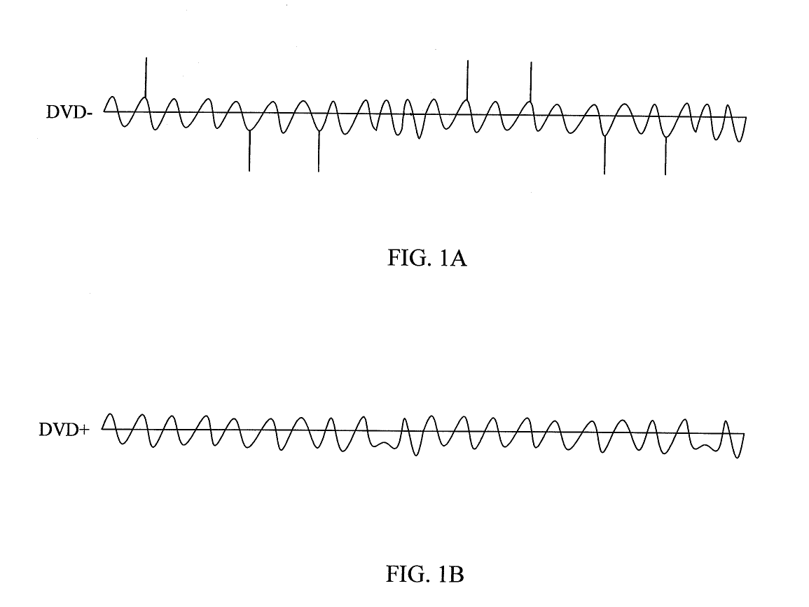

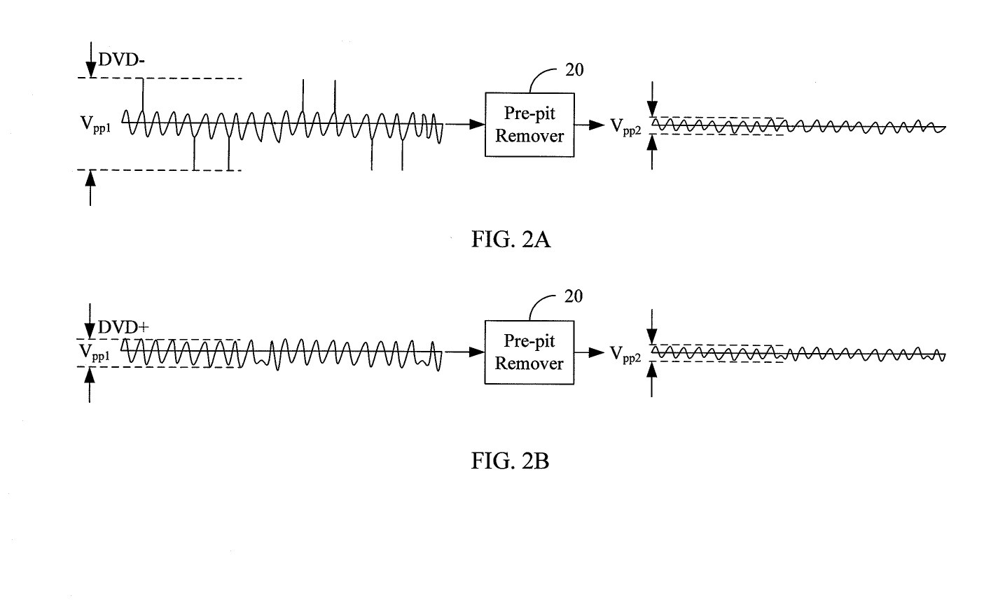

As described above, one of the differences between DVD− type and DVD+ type disks is the presence or absence of the pre-pit components in the wobble signal, as clearly shown in FIG. 1A and FIG. 1B. According to a first embodiment of the present invention, referring to FIG. 2A, if the wobble signal of a DVD− type (e.g. DVD-R or DVD-RW) disk indicated by a waveform at the left side of this drawing is processed by a pre-pit remover 20 to remove the pre-pit pulses, then a processed wobble signal indicated by a waveform at the right side of this drawing is obtained. A first peak-to-peak level Vₚₚ₁ of the wobble signal before processed by the pre-pit remover 20 is significantly larger than a second peak-to-peak level Vₚₚ₂ of the processed wobble signal. That is, Vₚₚ₁>Vₚₚ₂. In contrast, if the wobble signal of a DVD+ type (e.g. DVD+R or DVD+RW) disk indicated by a waveform at the left side of FIG. 2B is processed by a pre-pit remover 20, a processed wobble signal indicated by a waveform at the right side of this drawing is obtained. Since the wobble signal of the DVD+ type disk does not have the pre-pit component, the difference between a first peak-to-peak level Vₚₚ₁ of the wobble signal before processed by the pre-pit remover 20 and a second peak-to-peak level Vₚₚ₂ of the processed wobble signal is not remarkable. That is, Vₚₚ₁≈Vₚₚ₂. Accordingly, DVD− type and DVD+ type disks can be distinguished from each other according to the result of comparing Vₚₚ₁ and Vₚₚ₂.

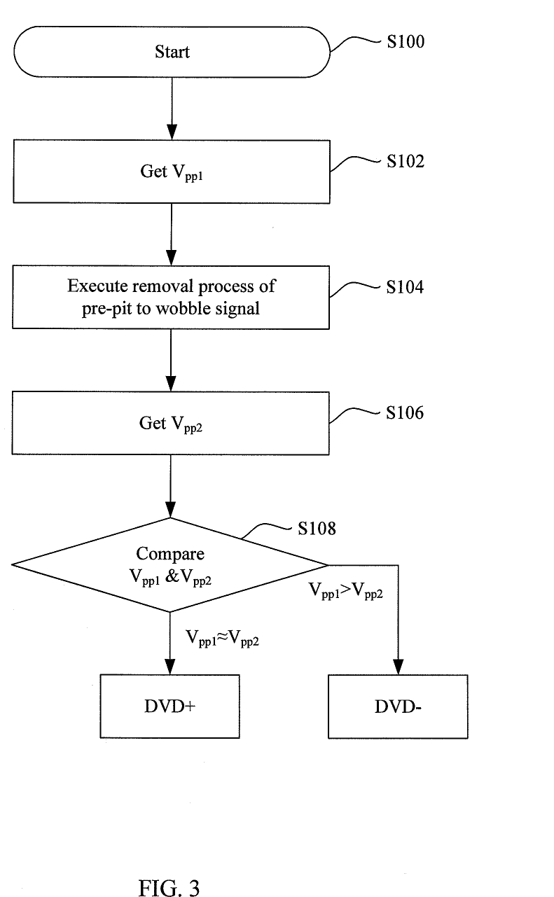

The method of the first embodiment in accordance with the present invention will be further described with reference to FIG. 3. In FIG. 3, the start of the method is indicated by step S100. In step S102, a peak-to-peak level of a wobble signal of a DVD disk is measured as a first peak-to-peak level Vₚₚ₁. Then, in step S104, a removal process of pre-pit pulses is executed to the wobble signal to remove the pre-pit component from the wobble signal, if any. In step S106, a measurement is performed to the wobble signal which has been processed by the removal process of pre-pit pulses in order to obtain a second peak-to-peak level Vₚₚ₂. Then, the first and second peak-to-peak levels Vₚₚ₁ and Vₚₚ₂ are compared in step S108. If Vₚₚ₁ is significantly larger than Vₚₚ₂, the DVD disk is determined as DVD− type. Otherwise, if a difference between Vₚₚ₁ and Vₚₚ₂ is less than a predetermined value, that is, Vₚₚ₁ and Vₚₚ₂ are not considerably different from each other, the DVD disk is determined as DVD+ type.

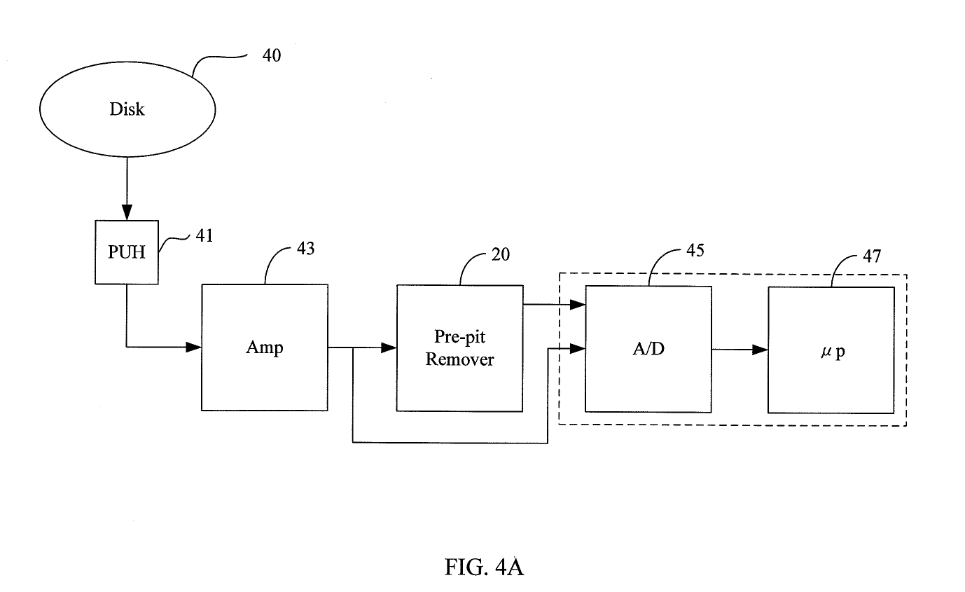

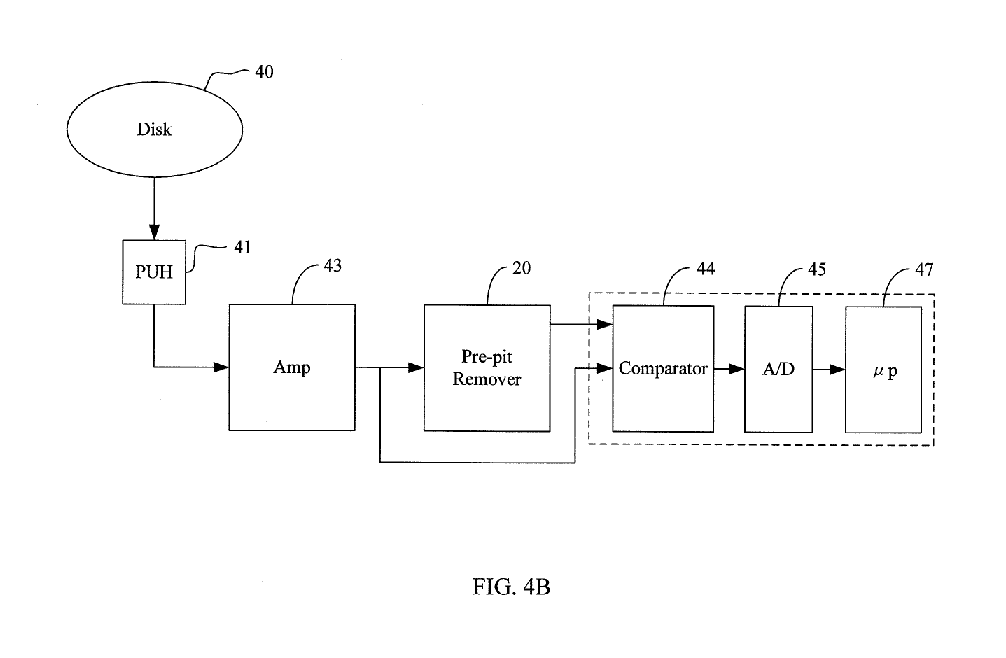

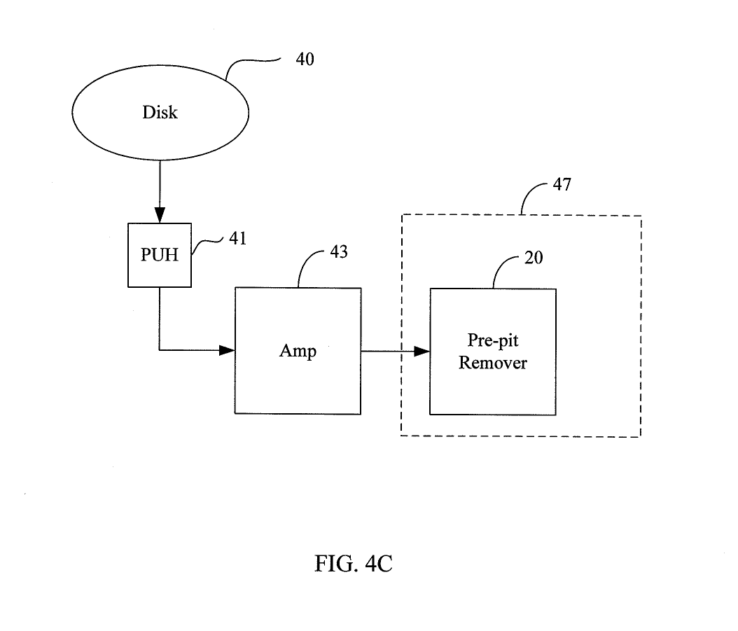

The identification method described above can be implemented with a device shown in FIG. 4A. As shown, a device in accordance with the present invention includes a pick up head (PUH) 41 for accessing a DVD optical disk 40 to get the wobble signal therefrom. The wobble signal is sent to an amplifier 43, then the amplified wobble signal is sent to the pre-pit remover 20. The pre-pit remover 20 executes the removal process of pre-pit to the wobble signal to remove the pre-pit component, if any.

The pre-pit remover 20 can be implemented in various manners. For a wobble signal including wobble component and pre-pit component, the slew rates, levels and frequencies are all very different for the wobble and pre-pit components. Accordingly, the pre-pit remover 20 can remove the pre-pit pulses by using the difference of slew rates, levels, or frequencies between the wobble and pre-pit components. The pre-pit remover 20 can be implemented by a slew rate limiter, such as an amplifier with a desired slew rate. In another case, the pre-pit remover 20 is implemented by a level limiter, which eliminates any signal with a level exceeding a predetermined value. In a further case, the pre-pit remover 20 is implemented by a frequency limiter, such as a low pass filter. In addition to the hardware, the pre-pit remover 20 can also be implemented with a program built in a processor, for example.

The wobble signal by-passing the pre-pit remover 20 and the wobble signal passing the pre-pit remover 20 are fed to an analog-to-digital (A/D) converter 45 to be converted into digital forms. The digitalized wobble signal that is not subjected to the pre-pit removal process of the pre-pit remover 20 and the digitalized wobble signal that is subjected to the pre-pit removal process of the pre-pit remover 20 are sent to a processor 47. The processor 47 functions as a decision unit to determine the type of the optical disk 40 by comparing the first peak-to-peak level Vₚₚ₁ of the wobble signal not subjected to the removal process and the second peak-to-peak level Vₚₚ₂ the wobble signal subjected to the removal process. In the embodiment, if Vₚₚ₁ is significantly larger than Vₚₚ₂, the DVD optical disk 40 is determined as DVD− type. If Vₚₚ₁ is similar to Vₚₚ₂, then the DVD optical disk 40 is determined as DVD+ type. Other determination rules can also be applied. The relevant conditions for such rules can be set in the processor 47.

Alternatively, as shown in FIG. 4B, the comparison of the peak-to-peak levels is done to the analog wobble signal not subjected to the pre-pit removal process and wobble signal subjected to the pre-pit removal process by a comparator 44, which can be implemented by a differential amplifier, for example. The comparison result is then converted to digital form by the analog-to-digital (A/D) converter 45, and the processor 47 then determines the type of the DVD disk 40 based on the comparison result.

As mentioned above, the pre-pit remover 20 can be implemented with a program. As shown in FIG. 4C, the pre-pit removing, comparing and determining are all executed in the processor 47 according to the program built within.

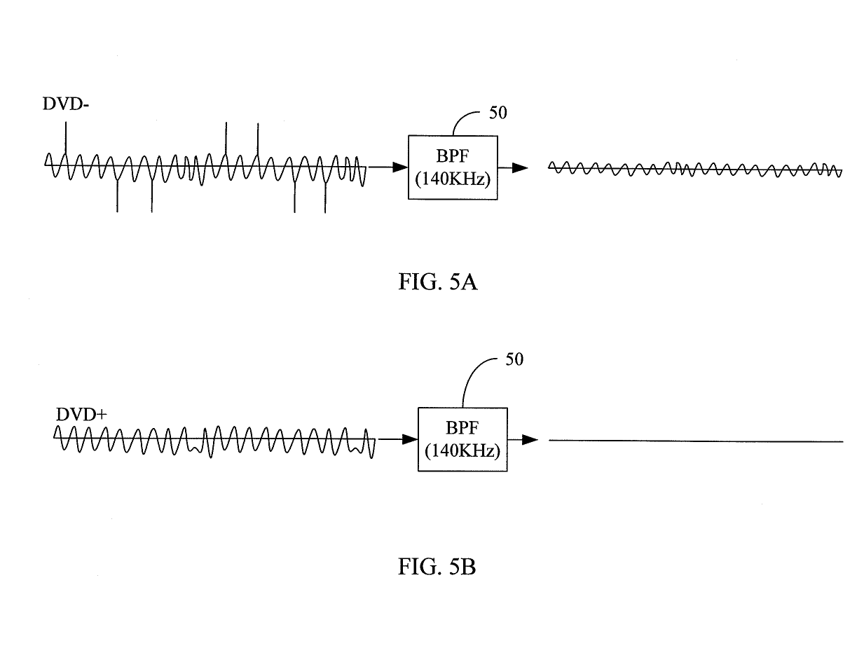

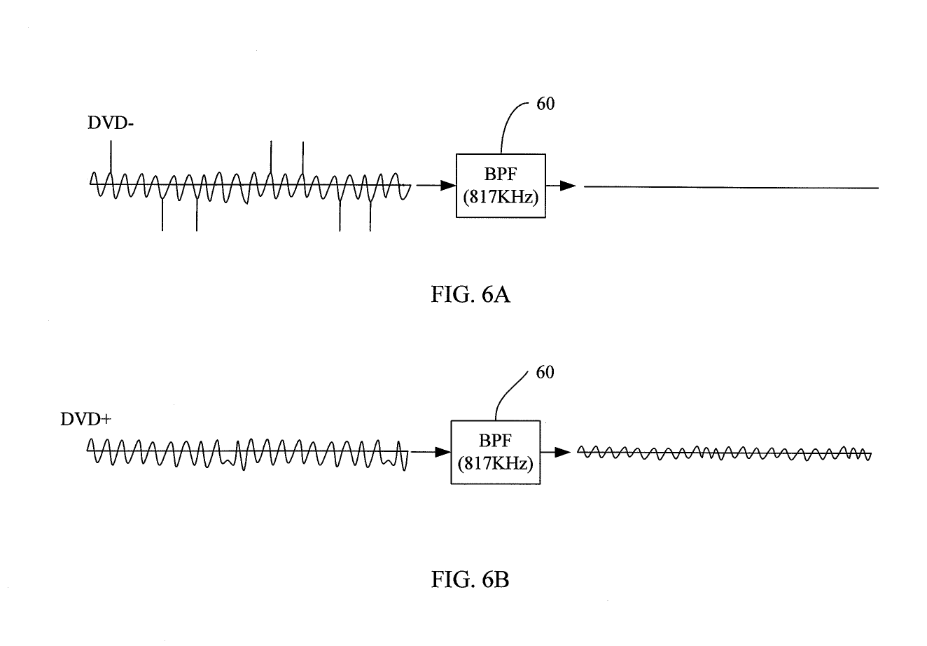

FIG. 5 and FIG. 6 show another identification method in accordance with the present invention. As shown in FIG. 5A, a band-pass filter (BPF) 50 with a frequency range defined based on the center frequency of the wobble of the DVD− type disk (e.g. about 140 kHz @ 1×; “@ 1×” indicates “at 1 time of rotation speed”) is provided. When the wobble signal of a DVD− type disk passes the BPF 50, the pre-pit component is filtered out, and the wobble component is left. The wobble is then fed to drive a spindle motor to rotate the optical disk. The spindle motor rotates at a normal speed. When the wobble signal of a DVD+ type disk passes the BPF, the wobble thereof with the carrier frequency of 817.4 kHz @1× is substantially filtered out, as shown in FIG. 5B. If the filtered DVD+ type wobble signal, which may only have some residual noises, is used to drive the spindle motor, then the spindle motor cannot rotate at a normal speed.

Similarly, as shown in FIG. 6A, a band-pass filter (BPF) 60 with a frequency range defined based on the center frequency of the wobble of the DVD+ type disk (e.g. about 817 kHz@1×) is alternatively provided. When the wobble signal of a DVD− type disk passes the BPF 60, the wobble component with the carrier frequency of 140.6 kHz@1× and pre-pit component thereof are both filtered out. If the filtered wobble signal, which may only have some residual noises, is used to drive the spindle motor, then the spindle motor cannot rotate at a normal speed. When the wobble signal of a DVD+ type disk passes the BPF 60, the wobble passes therethrough, it is as shown in FIG. 6B. The wobble is then fed to drive a spindle motor to rotate the optical disk. The spindle motor rotates at the normal speed under this condition.

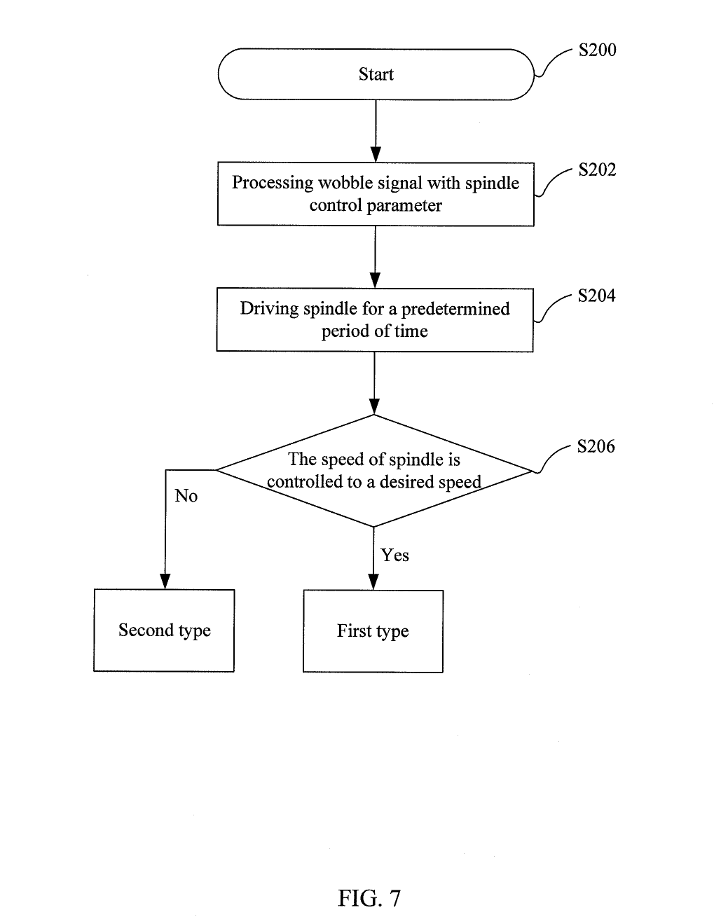

The second identification method will be further described with reference to the flow chart shown in FIG. 7. This identification method is started with step S200. In this method, a spindle control parameter for a first type of disks is set. In the embodiment, the parameter is the frequency range of the BPF defined according to the center frequency of the wobble of the first type of disks. If the first type is defined as DVD− type, the center frequency of the wobble is about 140 kHz@1×. In step 202, the wobble signal of a DVD disk to be identified is processed with the spindle control parameter. In the present embodiment, the wobble signal is filtered by the BPF 50. The processed wobble signal is then used to drive the spindle motor in step S204. After a predetermined period of time, usually a very short period, in step 206, if the spindle motor rotates at a desired speed, then the disk is determined as the first type (DVD− type); if the spindle motor fails to rotate at the desired speed, then the disk is determined as the second type (DVD+ type).

Alternatively, the first type can be set as DVD+, while the second type can be set as DVD−, the control parameter, that is, the frequency used to define the frequency range of BPF, should be modified accordingly. This method can also be used to identify other disk types with setting proper spindle control parameters.

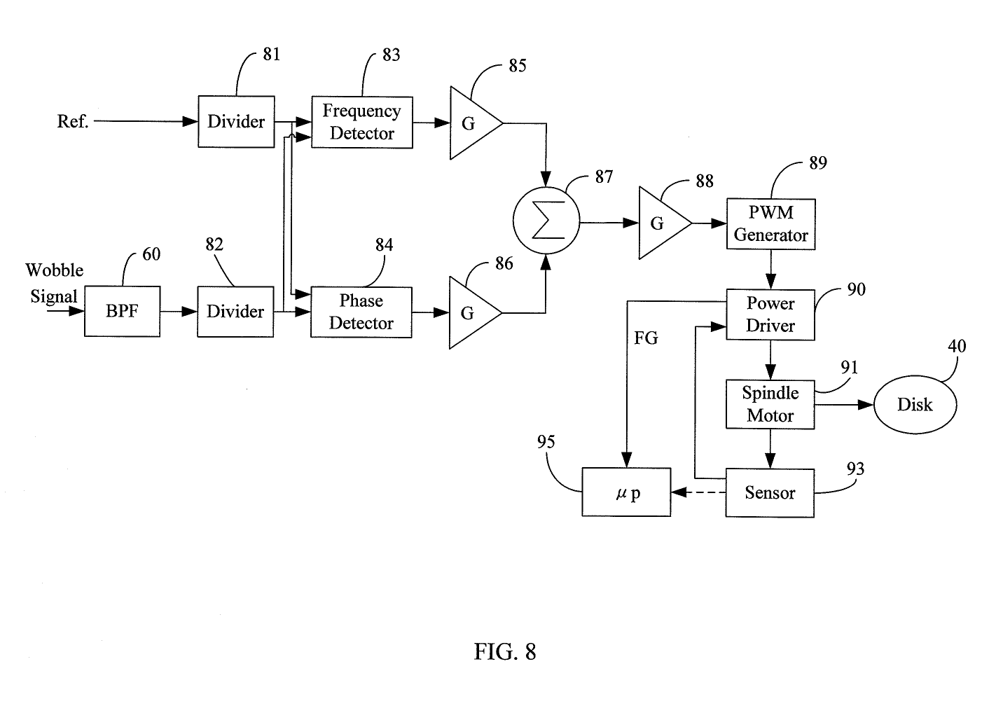

An example of a device for implementing the second identification method in accordance with the present invention is shown in FIG. 8. The wobble signal picked from a disk 40 is sent to a band-pass filter 60. The filtering range of the band-pass filter 60 is set based on the center frequency of the wobble of the DVD− type disk, for example. That is, the frequency range of the band-pass filter 60 is set in the proximity of the frequency about 140 kHz@1× in this embodiment. A reference signal (e.g. a crystal oscillation signal) and the band-pass filtered wobble signal are sent to frequency dividers 81 and 82, respectively. The outputs from the two dividers 81 and 82 are then fed to a frequency detector 93 and a phase detector 84 to be processed. Then the processed signals are sent to amplifiers 85 and 86, respectively, which provide proper gains. The amplified signals are summed by an adder 87, and the output of the adder 87 is sent to an amplifier 88 providing a proper gain. The amplified signal is then provided to a PWM generator 89. The PWM generator 89 generates a clock signal accordingly and provides the clock signal to a power drive 90. The power drive 90 then controls a spindle motor 91, thus rotating the disk 40 according to the clock signal. The rotation condition of the spindle motor is fed back to the power drive 90. For example, there can be a sensor 93 for sensing the rotation condition including the speed of the spindle motor 91. The sensor 93 feeds the sensed condition to the power drive 90. The power drive 90 then generates a rotation condition signal FG according to the sensed condition. The rotation condition signal FG is provided to a processor 95. Alternatively, the sensor 93 may provide the information of the rotation speed of the spindle motor 91 directly to the processor 95. If the processor 95 confirms that the spindle motor 91 rotates at a desired speed after a predetermined period of time, usually a very short period of time, then the processor 95 determines that the disk is DVD− type in this example. If the processor 95 finds that the spindle motor 91 fails to rotate at the desired speed after the predetermined period of time, the processor 95 determines that the disk is not DVD− type. In a specific case, the processor 95 may directly determines that the disk is DVD+ type under such a circumstance. In another example, a secondary band pass filter is provided for double checking the disk type if the disk has been determined as not a DVD− type disk. The secondary band pass filter has a frequency range defined based on the center frequency of the wobble of the DVD+ type.

In the above description, the disk to be identified is to be checked if it is a DVD− type disk first. That is, the predetermined type is DVD− type. However, the predetermined type can also be DVD+ type. Another disk type can also be set as the predetermined type with proper parameter designed.

While the preferred embodiments of the present invention have been illustrated and described in details, various modifications and alterations can be made by persons skilled in this art. The embodiments of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A method for identifying recording medium type, said recording medium carrying a wobble signal, said method comprising:
getting the wobble signal of the recording medium;
measuring a first peak-to-peak level of the wobble signal;
executing a removal process of pre-pit pulses to the wobble signal;
measuring a second peak-to-peak level of the wobble signal subjected to the removal step;
comparing the first and second peak-to-peak levels; and
determining a type of the recording medium based on a result of the comparing step.

2. The method as claimed in claim 1, wherein pre-pit pulses are removed in the removal process of pre-pit pulses according to the difference between slew rates of pre-pit and wobble of the wobble signal if there are pre-pit pulses carried in the wobble signal.

3. The method as claimed in claim 1, wherein pre-pit pulses are removed in the removal process of pre-pit pulses according to the difference between amplitudes of pre-pit and wobble of the wobble signal if there are the pre-pit pulses carried in the wobble signal.

4. The method as claimed in claim 1, wherein pre-pit pulses are removed in the removal process of pre-pit pulses according to the difference between frequencies of pre-pit and wobble of the wobble signal if there are pre-pit pulses carried in the wobble signal.

5. The method as claimed in claim 1, wherein the type of the recording medium is determined as a first type if the difference between the first and second peak-to-peak levels reaches a predetermined value.

6. The method as claimed in claim 5, wherein the first type is DVD− type.

7. The method as claimed in claim 1, wherein the type of the recording medium is determined as a second type if the difference between the first and second peak-to-peak levels is less than a predetermined level.

8. The method as claimed in claim 7, wherein the second type is DVD+ type.

9. A device for identifying recording medium type, said recording medium carrying a wobble signal, said device comprising:
a pick-up head for getting the wobble signal from a recording medium;
a pre-pit remover for removing pre-pit pulses from the wobble signal, if any; and
a comparison unit for comparing a first peak-to-peak level of the wobble signal not subjected to the removing operation of the pre-pit remover and a second peak-to-peak level of the wobble signal subjected to the removing operation of the pre-pit remover to generate a comparison result.

10. The device as claimed in claim 9, further comprising a decision unit for determining the type of the recording medium based on the comparison result of the comparison unit.

11. The device as claimed in claim 10, wherein the type of the recording medium is determined as a first type if the difference between the first and second peak-to-peak levels reaches a predetermined value.

12. The device as claimed in claim 11, wherein the first type is DVD− type.

13. The device as claimed in claim 10, wherein the type of the recording medium is determined as a second type if the difference between the first and second peak-to-peak levels is less than a predetermined level.

14. The device as claimed in claim 13, wherein the second type is DVD+ type.

15. The device as claimed in claim 9, wherein pre-pit remover removes pre-pit pulses from the wobble signal according to the difference between slew rates of pre-pit and wobble of the wobble signal if there are the pre-pit pulses carried in the wobble signal.

16. The device as claimed in claim 9, wherein pre-pit remover removes pre-pit pulses from the wobble signal according to the difference between amplitudes of pre-pit and wobble of the wobble signal if there are the pre-pit pulses carried in the wobble signal.

17. The device as claimed in claim 9, wherein pre-pit remover removes pre-pit pulses from the wobble signal according to the difference between frequencies of pre-pit and wobble of the wobble signal if there are the pre-pit pulses carried in the wobble signal.

18. A method for identifying recording medium type, said recording medium carrying a wobble signal, said method comprising:
getting the wobble signal of the recording medium;
processing the wobble signal with a predetermined parameter;
using the processed wobble signal to drive a spindle motor; and
observing the speed of the spindle motor for a predetermined period of time, if the spindle motor rotates in a predetermined speed, the recording medium is determined as a first type.

19. The method as claimed in claim 18, wherein the recording medium is determined as a second type if the spindle motor is failed to rotate in the predetermined speed.

20. The method as claimed in claim 19, wherein the first type is DVD− type, and the second type is DVD+ type.

21. The method as claimed in claim 19, wherein the first type is DVD+ type, and the second type is DVD− type.

22. The method as claimed in claim 18, wherein the processing step is to band-pass filter the wobble signal based on a frequency band;

23. The method as claimed in claim 22, wherein the frequency band is defined based on the center frequency of a wobble of the first type of recording medium.

24. The method as claimed in claim 18, wherein the first type is DVD− type.

25. The method as claimed in claim 18, wherein the first type is DVD+ type.

26. A device for identifying recording medium type, said recording medium carrying a wobble signal, said device comprising:
a pick-up head for accessing the recording medium to get the wobble signal;
a band pass filter for filtering the wobble signal with a range defined based on a predetermined center frequency;
a spindle motor for rotating the recording medium; and
a power driver for driving the spindle motor to rotate according to the filtered wobble signal, wherein the recording medium is determined as a predetermined type. If the spindle motor substantially rotates with an acceptable speed after a predetermined period of time, while it is determined as a type rather the predetermined type if the spindle motor fails to rotate with the acceptable speed after the predetermined period of time.

27. The device as claimed in claim 26, wherein the range of the band pass filter is defined based on the center frequency of the wobble of DVD− type, and the predetermined type is DVD− type.

28. The device as claimed in claim 27, the recording medium is determined as DVD+ type if the spindle motor fails to rotate with the acceptable speed after the predetermined period of time.

29. The device as claimed in claim 26, wherein the range of the band pass filter is defined based on the center frequency of the wobble of DVD+ type, and the predetermined type is DVD+ type.

30. The device as claimed in claim 29, the recording medium is determined as DVD− type if the spindle motor fails to rotate with the acceptable speed after the predetermined period of time.

31. The device as claimed in claim 26, further comprising a processor for determining if the recording medium is the predetermined type according to the speed of the spindle motor.

32. The device as claimed in claim 31, wherein the power driver generates a rotation condition signal according to the rotation of the spindle motor, and the processor determines the type of the recording medium according to the rotation condition signal.

33. The device as claimed in claim 31, wherein the processor determines the type of the recording medium according to a rotation speed sensed from the spindle motor.
